(19) United States
(12) Patent Application Publication
(10) Pub. No.: US 2015/0305554 A1
(43) Pub. Date: Oct. 29, 2015

(54) TWO-SIDED GRILL AND METHOD

(71) Applicant: Restaurant Technology, Inc., Oak Brook, IL (US)

(72) Inventors: Ron Dorsten, Glenview, IL (US); Henry T. Ewald, Oracle, AZ (US); Manuel Calzada, Rolling Meadows, IL (US)

(73) Assignee: Restaurant Technology, Inc., Oak Brook, IL (US)

(21) Appl. No.: 14/262,026

(22) Filed: Apr. 25, 2014

(51) Int. Cl. A47J 37/06; A23L 1/01

(52) U.S. Cl. CPC A47J 37/0611; A23L 1/01; A47J 2037/0617

(57) ABSTRACT

Two-sided grills are provided having a positively controlled vertical gap between two opposed cooking surfaces, means for detecting initial contact of an upper cooking surface on a food item placed on a lower cooking surface, means for measuring the gap between the cooking surfaces at the initial contact position to determine a thickness of the food item and a food-item type, and a control system for automatically initiating a pre-programmed cooking routine based on the food-item type. The cooking routine includes varying the gap dimension between the platens while cooking the food item, the range or sequence of gap dimension variation being based on either the measured thickness of the food item or a nominal thickness associated with the identified food item type. In other aspect, grills according to the invention may include a lower platen mounted for vertical movement and an upper platen mounted only for pivoting.

### FIELD OF THE INVENTION

The present invention relates to two-sided grills having opposable upper and lower cooking surfaces and methods of using them to cook food items disposed between the opposed upper and lower cooking surfaces. More particularly, the present invention relates to apparatus and methods for adjusting a gap distance between opposed cooking surfaces in a cooking orientation.

### BACKGROUND OF THE INVENTION

Two-sided or “clamshell” grills, having opposed or opposable upper and lower heated platens, have long been used for rapid grilling of food items, such as one or more groups of hamburger patties or chicken breasts at a time. Such grills allow a plurality of food items simultaneously and are particularly suited for use in quick-service restaurants to cook hamburger patties and other food items. Such food products are often designed to have a uniform or nominal product thickness. However, clamshell grills have been observed to cook food items inconsistently, particularly from batch to batch.

A need therefore exists for improved two-sided grills and methods that provide improved cooked product consistency, particularly where the actual and/or nominal product thickness varies from batch to batch or lot to lot.

A need also exists for a two-sided grill having opposed platens that can be controlled more reliably to provide a desired distance between the platen surfaces during cooking and to provide a desired change or changes to that distance during cooking.

### SUMMARY OF THE INVENTION

In accordance with one aspect of the present invention, a grill device for simultaneous two-sided cooking is provided. The grill device comprises an upper cooking platen and a lower cooking platen, the upper cooking platen mounted for at least one degree of freedom of movement relative to the lower cooking platen for movement between a cooking position and a non-cooking position, and the lower cooking platen mounted in generally opposed relation to the upper cooking platen in the cooking position. The lower platen mounted for vertical movement from a non-cooking position substantially below the upper platen in the cooking position to a cooking position closer to the upper platen. Typically, the non-cooking position of the lower platen is spaced from the upper platen in its cooking position by a distance that is sufficiently larger than a characteristic height of a tallest food item type cooked on the grill to consistently leave a clearance between a food item placed on the lower platen and the cooking surface of the upper platen when the upper platen is lowered to its cooking position. This is because first contact of the food item on the upper platen occurring during a phase of linear vertical movement of the lower platen, with the upper platen fixed, generally facilitates simpler automatic determination of food item thickness than first contact occurring during a phase of angular movement of the upper platen down to its cooking position. Optionally, the upper cooking platen may be mounted to a support structure for movement consisting only of rotation about a generally horizontal axis in fixed relation to said support structure. Additionally, suitable mechanical, electromechanical, and/or other structure may be provided for fixing the position of the upper cooking platen in the cooking position, or restraining its movement away from the cooking position.

Automated structure for vertically moving the lower platen are preferably provided. Such automated structure may be configured to control the vertical position of the lower platen relative to the upper platen when the upper platen is in the cooking position and/or to control a force or pressure applied by the platens to a food item disposed between them. Force or pressure control may for example be provided by the cooperation of a position controlling component, a pressure or force sensing component, and a feedback controller that adjusts position based on a sensed pressure or force. Alternatively, force or pressure could be controlled by more directly controlling the magnitude of an input force, such as by using gas or hydraulic cylinders, adjusting current to a motor or electromagnet, engaging a selected constant-force spring, by engaging a selected counterweight to a lever, pulley, or equivalent mechanism. Automated position controlling structure may comprise a prime mover or motive device operatively connected to the lower platen by an at least substantially rigid mechanical linkage, facilitating bidirectional control of lower platen vertical movement. Advantageously, the automated motive structure for the lower platen may comprise an independent structure for changing the vertical positions of different portions of the lower platen, or other suitable structure for tilting the lower platen. Such motive means combined with means for detecting whether the platens are parallel and a suitable controller provide for calibration of platen parallelism.

In accordance with an another aspect of the invention, a method of cooking food item using a two-sided grill having automated control and opposed upper and lower cooking platens is provided. The method comprises automatically determining a food item height, and executing a cooking routine determined by the food item height. In particular, at least one food item having a nominal height is placed on a lower cooking platen of a grill, at least one of the upper cooking platen and the lower cooking platen is moved toward the other platen, and first contact of the upper platen on the food item is detected, such as by suitable force/pressure, temperature, or distance sensing means. The distance between the platens when the upper cooking platen first contacts the food item is automatically measured to measure the food item height, and a cooking routine stored in the memory for a food item type associated with the measured height, such as by the measured height being close to a nominal height for a particular food item type stored in a computer accessible memory.

The cooking routine comprises moving the platens relative to each other to at least a first cooking distance between the platens equal to a first percentage of the measured distance defined by the cooking routine, and heating the food item between the platens at the first cooking distance for a period of time determined by the automated control. Optionally, the cooking routine further includes moving the platens to a second cooking distance equal to a second percentage, different from the first percentage, of the measured distance defined by the cooking routine and heating the food item between the platens separated by the second cooking distance for a period of time determined by the automated control. The first percentage is optionally but typically less than the measured food item height, although the first and second percentages may each be less than, equal to, or greater than the measured height. The method optionally includes, after positioning the upper cooking platen in the cooking position, and before the upper cooking platen first contacts the food item, fixing the vertical position of the upper cooking platen in the cooking position.

According to still another aspect of the invention, a grill for simultaneous two-sided cooking is provided. The grill may be of a type as previously described or of some other type of simultaneous two-sided cooking grill having two cooking platens. A lower cooking platen of the grill is disposed generally opposite an upper cooking platen when the cooking platens are disposed for cooking. A non-stick cooking sheet is removably attached to at least one of the upper and lower cooking platens to cover at least a portion of a cooking surface of that cooking platen so that a terminal portion of the non-stick cooking sheet extends downwardly from a location proximate to that cooking platen surface having the release sheet thereover when that cooking platen is in the cooking position to a location generally above or within a liquid cooking waste receiving location disposed generally below the cooking platens. This facilitates runoff of liquid cooking waste from the terminal portion of the release sheet into a liquid cooking waste receptacle disposed generally below the terminal portion of the non-stick cooking sheet.

In accordance with yet another aspect of the invention, an alternative method of simultaneous two-sided cooking is provided. The method comprises providing an upper cooking platen and a lower cooking platen, the upper platen mounted for at least one degree of freedom of movement relative to the lower platen for movement between an upper platen cooking position and an upper platen non-cooking position, and the lower platen mounted in generally opposed relation to the upper platen in the cooking position, the lower platen mounted for vertical movement of the lower platen from a lower platen non-cooking position substantially below the upper platen in the cooking position to a lower platen cooking position in which the lower platen is closer to the upper platen. A food item to be cooked is placed on a cooking surface of the lower platen in the lower platen non-cooking position, the food item having a vertical dimension that is smaller than the distance between the lower platen cooking surface in the non-cooking position and the cooking surface of the upper platen in the cooking position. Then, the upper platen is moved to the upper platen cooking position, preferably before the lower platen is moved to the lower platen cooking position. When both platens are in their respective cooking positions, the food item is cooked while in contact with both platens simultaneously.

In accordance with still another aspect of the invention, another alternative grill device for simultaneous two-sided cooking is provided. The device comprises an upper cooking platen and a lower cooking platen disposed in generally opposed relation to each other when each platen is in a respective cooking position. At least a first one of the platens being driven by a gross vertical motive device for gross vertical movement from a first platen non-cooking position generally toward the second platen to a first platen cooking position. Additionally, the first platen, second platen, or each of them is driven by a fine tilting motive device independent of the gross vertical motive device for fine tilting movement about at least two generally horizontal axes. The fine tilting motive device may comprise plural linear motive devices, such as three of them spaced apart in a non-collinear arrangement, so that movement of any of the devices by a different distance than the others will change the tilt of the platen. Alternatively, the fine tilting motive device may comprise one or more devices that directly rotates the adjusted platen, such as two independent devices that purely rotate the platen about generally perpendicular axes. In general, the gross vertical motive device produces a range of vertical motion of the first platen greater than a range of vertical motion imparted to any part of a platen by the fine tilting motive device. For example, if the gross vertical motive device is a telescoping, piston-cylinder, or otherwise extending and retracting linear actuator, and the fine tilting motive device comprises plural such actuators, the gross vertical motive linear actuator will have a greater difference between its fully extended and fully retracted lengths than any of the fine tilting linear actuators.

The automated control and controllers referred to herein can comprise a microprocessor or microcontroller, suitably programmed to effect the calibrations, cooking routines and other functions as described herein.

### BRIEF DESCRIPTION OF THE DRAWINGS

FIG. 1 is a schematic side elevation view of a clamshell grill according to an aspect of the invention, showing an upper platen in a raised non-cooking position.

FIG. 2 is a schematic side elevation view of the clamshell grill shown in FIG. 1, showing the upper platen restrained in a lowered cooking position.

FIG. 3a is a schematic side elevation view of the clamshell grill shown in FIG. 1, showing a portion of a non-parallel lower platen contacting a portion of the upper platen.

FIG. 3b is a bottom plan view of a lower platen of the clamshell grill shown in FIG. 1, illustrating the relative locations of motive devices that drive the lower platen.

FIG. 4 is a schematic side elevation view of the clamshell grill shown in FIG. 1, showing upper and lower platens of the grill in flush contact.

FIG. 5 is a schematic side elevation view of the clamshell grill shown in FIG. 1, showing the upper platen in a raised non-cooking position, and food items placed on the lower platen ready to be cooked.

FIG. 6 is a schematic side elevation view of a clamshell grill generally according to FIG. 1, modified to include sensors in the upper platen and showing the upper platen in a cooking position, the food items on the lower platen not contacting the upper platen.

FIG. 7 is a schematic side elevation view of the clamshell grill shown in FIG. 1, illustrating initial contact of food items on the upper cooking platen in a cooking position.

FIG. 8 is a schematic side elevation view of the clamshell grill shown in FIG. 1, illustrating the compression or shrinking of food items being cooked between the upper and lower platens to a reduced height.

FIG. 9a is a schematic side elevation view of an alternative embodiment of a clamshell grill according to the invention, including an upper platen that is movably mounted to a pivotable upper platen housing, the upper platen housing being restrained in a cooking position.

FIG. 9b is a schematic side elevation view of another alternative clamshell grill, including an upper platen that is movably mounted to a pivotable upper platen housing, the upper platen housing being restrained with respect to a base structure, and the lower platen being permanently fixed with respect to the base structure.

FIG. 9c is a side elevation view of still another alternative clamshell grill, including a vertically movable platform for gross vertical movement of a lower platen.

FIG. 10 is a schematic side elevation view of components of a clamshell grill, illustrating yet another aspect of the invention.

FIG. 11a is a schematic top plan view of the clamshell grill components shown in FIG. 10.

FIG. 11b is a schematic top plan view of a non-stick cooking sheet shown in FIGS. 10 and 11a, unfolded to a flat configuration.

FIG. 12 is a schematic, cross-sectional side elevation view of clamshell grill components illustrating still another aspect of the invention.

### DESCRIPTION OF THE INVENTION

The inventive two-sided or clamshell grills and methods will now be described in detail. The present invention provides several advantages over existing grills and methods, including the ability for more precise and more versatile gap-distance control, improved programming of gap distance variation during a cooking routine, simplification of mechanisms, and improved grease splatter and grease runoff control, containment and collection. The non-limiting embodiments described and illustrated with reference to the accompanying drawings provide examples of how these advantages may be attained in accordance with the invention.

It has been discovered that food items intended to be cooked on a two-sided grill, such as hamburger patties, have variations in thickness, particularly from lot to lot of such items. This is despite a design, characteristic or nominal thickness that is intended to be uniform from lot to lot.

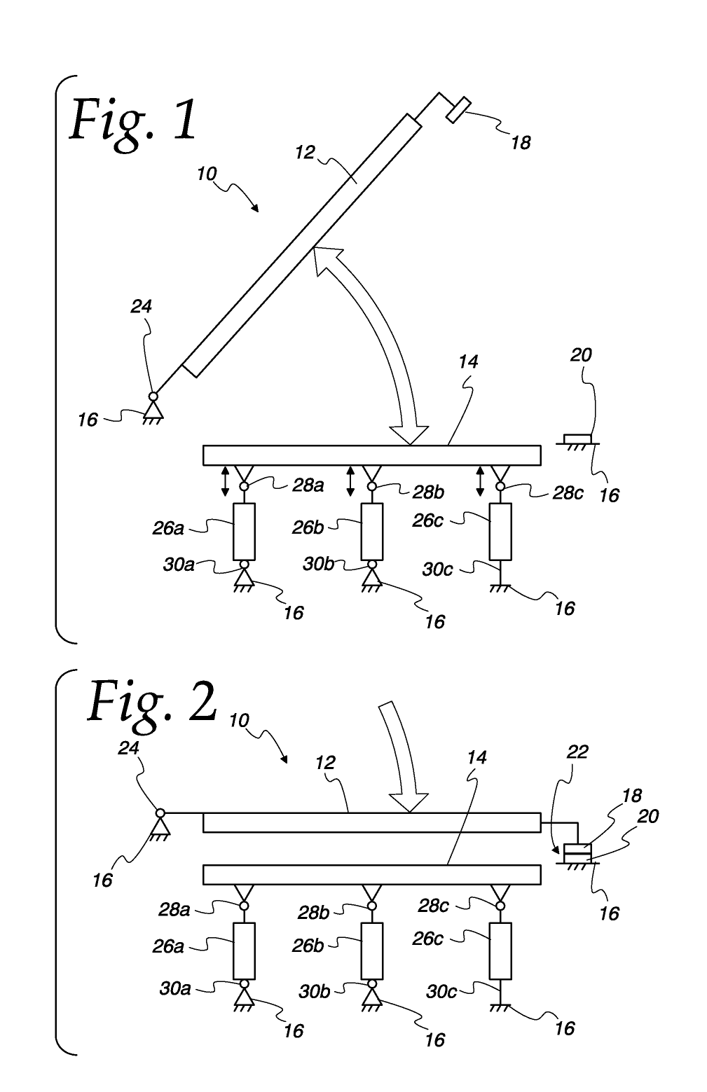

Referring to FIGS. 1-8, a clamshell grill 10 and methods of using it according to the invention are illustrated in schematic drawings. Grill 10 includes an upper platen 12, and a lower platen 14. Suitable heating elements for heating the cooking surfaces of platens 12 and 14 are provided and may be of any suitable type known in the art. Upper platen 12 is mounted to a base 16 for pivotal movement to and from a generally horizontal cooking position opposed to lower platen 14, as shown in FIG. 2, and a raised, generally relatively vertical non-cooking position, as shown in FIG. 1. Lower platen 14 is mounted to base 16 for up and down vertical movement a relatively substantial distance, such as about one or more inches between platens 12 and 14 when platen 12 is in the cooking position, to adjust the gap or distance between the platen cooking surfaces of platens 12 and 14 when opposed before, during and after cooking. Typically, that gap or distance between the two platens is between about 0 inches (the platen cooking surfaces are in contact or close to contact with each other) and about 1 or more inches (e.g., 1.5, 2, 2.5, 3, 3.5 or 4 inches) or as otherwise desired in configuring the grill. In addition, the lower platen is mounted to base 16 for relative tilting movement to adjust for parallelism between opposed cooking surfaces of platens 12 and 14 when in a cooking position. In the illustrated embodiment, lower platen 14 is depicted as being supported and driven as described above by three linear actuators 26a, 26b, and 26c, connected proximate to three different portions of lower platen 14 by respective lower platen pivotal joints 28a, 28b, and 28c. Those pivotal joints may be any suitable type, for example, ball joints, universal joints, or equivalent joints permitting rotation about any axis extending through the joint, and to base 16 by respective joints 30a, 30b, and 30c, two of which may be ball joints, universal joints, or equivalent joints, and at least one of which is a fixed or solid joint, shown as joint 30c in the figure, to prevent unwanted movement, including lateral movement and tilting. Alternatively, two or all three of joints 30a, 30b, and 30c may be fixed or solid joints. It is readily understood that in an ideal linkage, all three joints being solid joints would cause the linkage to lock, as at least one of linear actuators 26a, 26b, and 26c must change its angular position to accommodate any tilt of lower platen 14. However, one skilled in the art will recognize that, in practice, bending compliance of the members of the linear actuators, and/or play or clearances, such as in the sliding fit between their piston and cylinder components, for example, will be sufficient to accommodate the minor amount of deviation from a horizontal plane that typically occurs during normal use of a grill platen. Indeed, all three of joints 30a, 30b, and 30c being solid joints may in some circumstances be preferred, as nominal pivotal freedom of the linear actuators, when combined with the practical effects of a non-ideal mechanism having clearances and compliances, may result in more than a desired amount of play in the mechanism.

One skilled in the art will also recognize that, although three linear actuators are generally sufficient to control the vertical displacement and tilt of a platen, it may be convenient to provide more than three linear actuators to provide more modes of adjustment. For example, if four linear actuators are provided, for example each being connected near one of the corners of a rectangular platen by a ball joint, universal joint, or equivalent joint for pivoting in any direction, then a tilting adjustment of the platen may be made by extending or retracting any one of the actuators, while at the same time disengaging a drive or other controlling means from one of the other actuators to permit it to passively respond, and fixing the lengths of the other two actuators. Four linear actuators would thus provide four pivotal axes to choose from to make a tilting adjustment instead of only three, which may permit corrections requiring less energy and/or fewer steps.

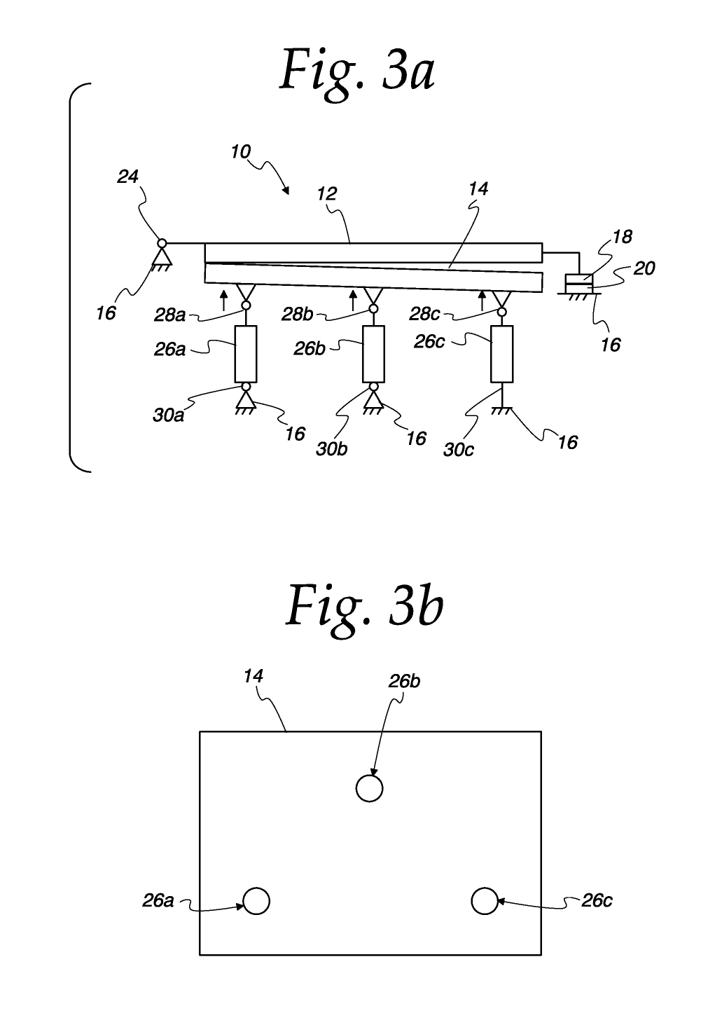

Though not apparent from a side elevational schematic, it will be understood that lower platen pivotal joints 28a, 28b, and 28c are arranged in a non-collinear relationship, preferably approximating an equilateral triangle in a plane disposed parallel to and below a cooking surface of lower platen 14, so that extending and retracting any one of linear actuators 26a, 26b, and 26c effects rotation of lower platen 14 about an axis determined by the positions of the pivotal joints associated with the other two actuators, in addition to generally raising and lowering a portion of lower platen 14 proximate to the respective pivotal joint. Thus, for example, extending and retracting linear actuator 26a will effect raising and lowering of a portion of lower platen 14 proximate to lower platen pivotal joint 28a and rotation of lower platen 14 about an axis generally extending through pivotal joints 28b and 28c. Preferably, those actuators are in an equilateral triangular array or an approximately generally equilateral triangular array, as shown in the bottom plan view of lower platen 14 of FIG. 3b. In addition, it is to be understood that four or more actuators could be used in place of three actuators to effect the vertical up and down and tilting movement of platen 14 as described above. With four actuators, preferably a generally rectangular or square array would be utilized. It will also be understood that motive devices suitable for manipulating lower platen 14 may be but are not required to be linear actuators, but may instead be devices that produce rotation of a driven rotor and convert that rotation into vertical translation of lower platen 14 or a portion thereof, such as by the action of a threaded vertical shaft or a vertical rack-and-pinion gear arrangement, or into rotary movement of lower platen 14, such as by a train of spur gears. Suitable motive devices include pneumatic or hydraulic cylinders, motors connected to lower platen 14 by any suitable drive linkage which may comprise rigid and/or flexible components, such as gears, shafts, cables, belts or other components in any suitable combination, and any other suitable type of motive device/prime mover. Optionally, though not shown, a component of movement of a lower platen may also be effected in part by a force passively transmitted to the lower platen by a stationary object or force field when the motive device drives the lower platen into contact with the stationary object or into the influence of the force field, such as a magnetic field.

For upper platen 12, suitable restraining structure is provided to prevent upper platen 12 from moving away from lower platen 14 when upper platen 12 is placed in the cooking position. The restraining structure typically prevents rotational movement of the upper platen towards and away from the lower platen. In alternative embodiments, the restraining structure may only prevent movement of the upper platen towards the lower platen, so that the weight of the upper platen is solely relied upon to restrain movement of the upper platen away from the lower platen. Any suitable restraining structure can be employed as will be understood by those skilled in the art. In one embodiment the restraining structure may be a mechanical and/or electromechanical device. For example, a suitable mechanical restraining structure may comprise a combination of latch and a hook, catch, or plate that abuts the latch to oppose separating movement in at least one direction, or of a biased gripping member seated in a groove or channel aligned perpendicularly to the direction of restrained movement, one or both of the gripping member and the groove or channel being tapered so that a sufficient force in the direction of restrained movement will cam the spring-loaded gripping member out of the groove or channel to remove the restraint of movement in the restrained direction. A suitable electromechanical device may comprise an electromagnet that attracts one component of the restraining structure to another with a magnetic force to restrain relative movement of the components apart from each other (in which case the two components need not touch), or which magnetically biases a mechanical member into a position that prevents or restrains such separating movement. For example, in the latter case the electromagnet may attract a latch or gripping member into a position restraining or preventing movement separating the restraining structure components, and in the event of a loss of power to or other failure of the grill, the electromagnet may shut off, permitting gravity or another counter-biasing force to move the latch or gripping member to a freeing position that removes the restraint of movement separating the components.

Restraining structure 22 effectively operates to limit or remove the degree of freedom of movement provided by pivotal joint 24. As such, the restraining structure may be located in or operatively associated with rotational movement of pivotal joint 24, such as a selectively engaged ratcheting mechanism (not shown). In the case of automated raising and lowering of upper platen 12 between the cooking and non-cooking positions, the restraining structure may be comprised in a motive device or drive train or linkage that drives the automated rotation of a pivotal shaft of pivotal joint 24. However, it may be desirable instead (or additionally) to locate restraining structure 22 remotely from pivotal joint 24, one advantage of doing so being that the leverage provided by increasing distance from pivotal joint 24 reduces the force required to restrain pivotal movement. For example, a restraining structure 22 may comprise an upper platen restraining component 18 fixed proximate to an end of the upper platen housing remote from the pivotal joint, cooperating with a fixed restraining component 20 fixed with respect to base 16 to restrain separation of the two components. Restraining structure 22 preferably provides at least enough resistance to oppose any upward force on upper platen restraining component 18 of a magnitude that would typically result from upward pressure applied by food items on grill 10 to a cooking surface of upper platen 12. By thus effectively fixing the position of upper platen 12, restraining structure 22 enables gap distance, platen parallelism, and pressure applied to food items on grill 10 to be controlled by controlling the position and movement of lower platen 14 or forces applied by one or more suitable motive devices to lower platen 14. As noted above, although the motive devices are depicted as linear actuators 26a, 26b, and 26c, many other types of motive devices are possible.

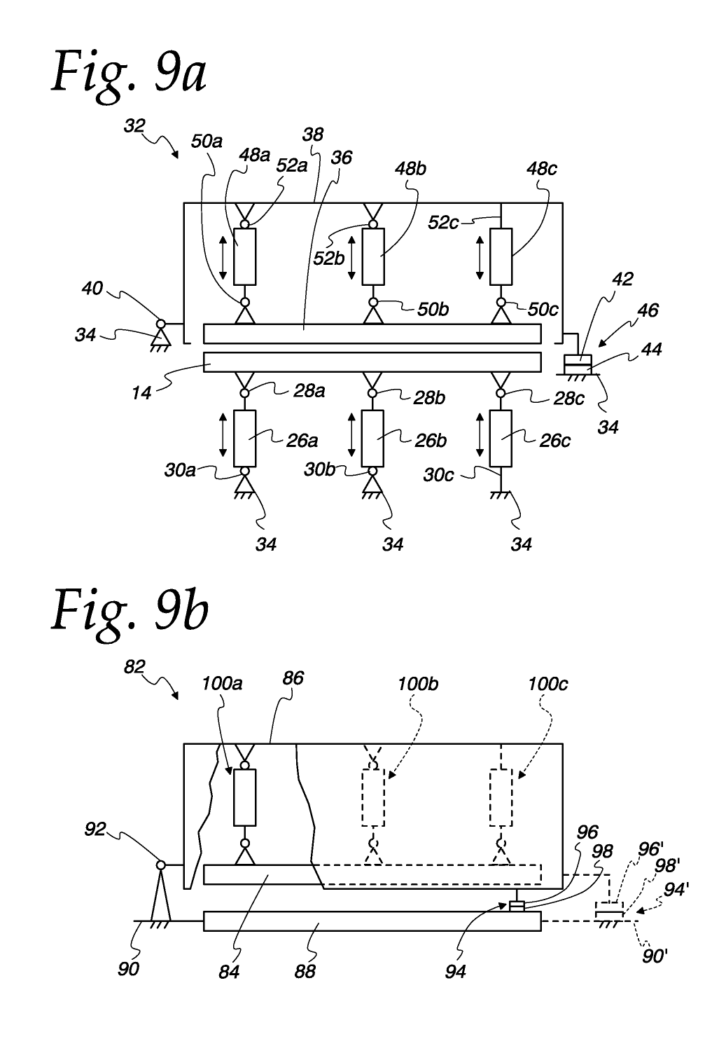

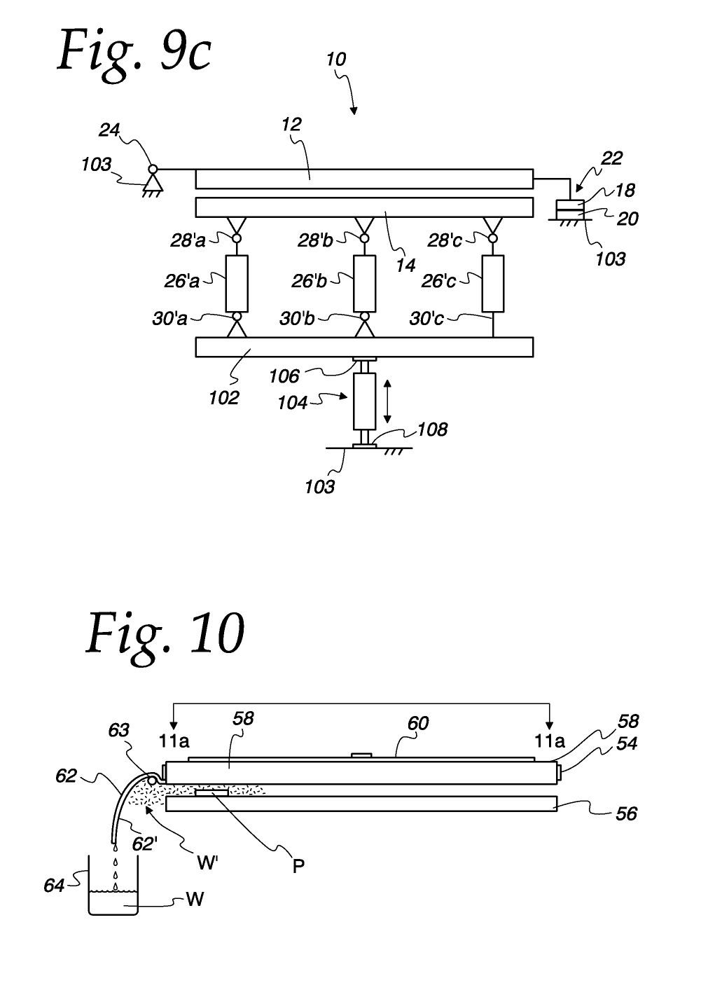

Although the illustrated embodiment thus depicted shows platens 12 and 14 as being mounted to the “same” support structure schematically represented as a base 16, it will be readily understood that base 16 is not necessarily a single contiguous structure, but may instead comprise multiple distinct structures that are generally stationary relative to one another, thus defining a common frame of reference for defining the positions and/or movements of the two platens. Thus, in addition to the possibility of both platens being supported by a unitary base, one or both platens may be supported by a structure mounted to a wall of a building or other suitable support, for example, or each platen may be supported by a separate base, the separate bases in turn being independently supported by a floor, wall or other suitable support. Alternatively, a lower platen supported on a floor surface may be or form an integral part of the support for the upper platen. Further, although upper platen 12 is depicted as mounted only for pivoting about a single axis fixed with respect to base 16, an upper platen may be movably retained in an upper platen housing for rotational or translational movement with respect to the housing (as described in more detail below with reference to FIGS. 9a and 9b), an upper platen housing itself may be translatable as well as pivotable, or pivotable about plural axes, with respect to a base, or any combination of these or other suitable linking relationships between an upper platen and a fixed base or support structure may be present.

Systems and methods of detecting and adjusting parallelism or relative tilt of opposed platens, automatically identifying a type of food item that is placed on a grill, and automatically determining and executing a cooking routine for a food item placed on a two-sided grill will now be described. With reference to FIGS. 1-8, a sequence of schematic drawings is presented to illustrate methods of calibrating the platens of a two-sided grill for parallelism and of using the two-sided grill to cook food items between the platens.

Turning to FIG. 1, an “initial” (for purposes of illustration) position of platens 12 and 14 is illustrated, in which upper platen 12 is in a raised, non-cooking position. A first step of a method of calibrating gap position and parallelism of platens 12 and 14 is lowering upper platen 12 from the non-cooking position to the generally horizontal cooking position illustrated in FIG. 2, in which, as noted above, upper platen restraining component 18 engages base restraining component 20 to restrain further downward pivoting of upper platen 12, and preferably also to restrain upward pivoting of upper platen 12 away from the cooking position.

Next, the position of lower platen 14 is adjusted to calibrate for parallelism of platens 12 and 14. Detection of parallelism or relative tilt in a two-sided grill may be performed in any suitable manner using any suitable device or devices, including but not limited to motive devices with encoder shafts or other drive members to track the displacement of different portions of one or both platens, levels, non-contact distance sensors, inertial sensors, accelerometers, while calibration or corrective adjustment for parallelism may be performed by any suitable motive device capable of changing the tilt as needed to effect a parallel relation between platen surfaces of one or both platen cooking surfaces with respect to the plane of the opposed cooking surface.

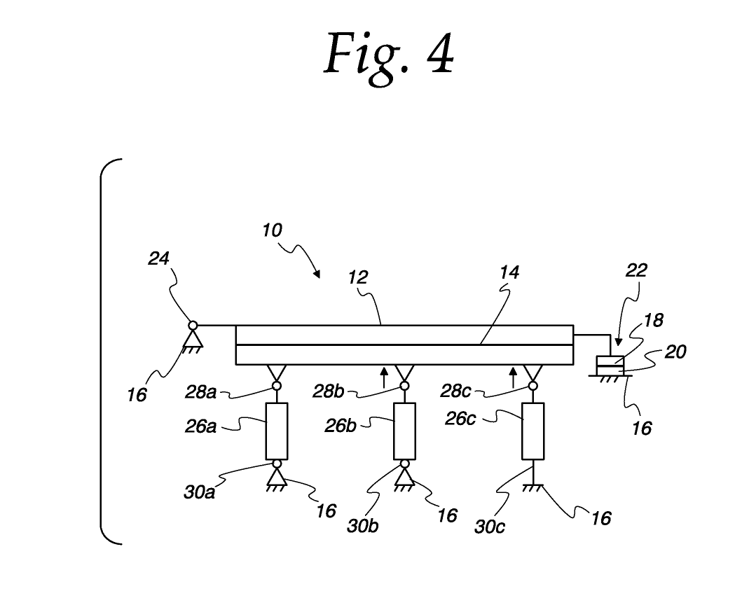

In the illustrated example, lower platen 14 is first raised vertically until it contacts upper platen 12, as shown in FIG. 3. This initial contact may be recognized, for example, by a component of the grill detecting a sudden increase in the resistance encountered by one or more motive devices 26a, 26b, and 26c, which may especially be noted in the motive device closest to a portion of lower platen 14 that first contacts upper platen 12 or by an electrical resistance charge between the platens, for example. At this point, power to the motive device closest to the initial point of contact may be reduced, while the other motive devices continue to operate at a normal rate until lower platen 14 is fully flush with upper platen 12, as illustrated in FIG. 4, and zero-gap displacement positions of the motive devices are recorded. Recording of the positions of the motive devices can be performed in any suitable manner by any suitable component; for example, the motive devices may comprise rotary or linear encoder shafts operatively linked to an electronic control processor, as described in more detail below with reference to a control processor 33 shown in FIG. 6, to track their displacement.

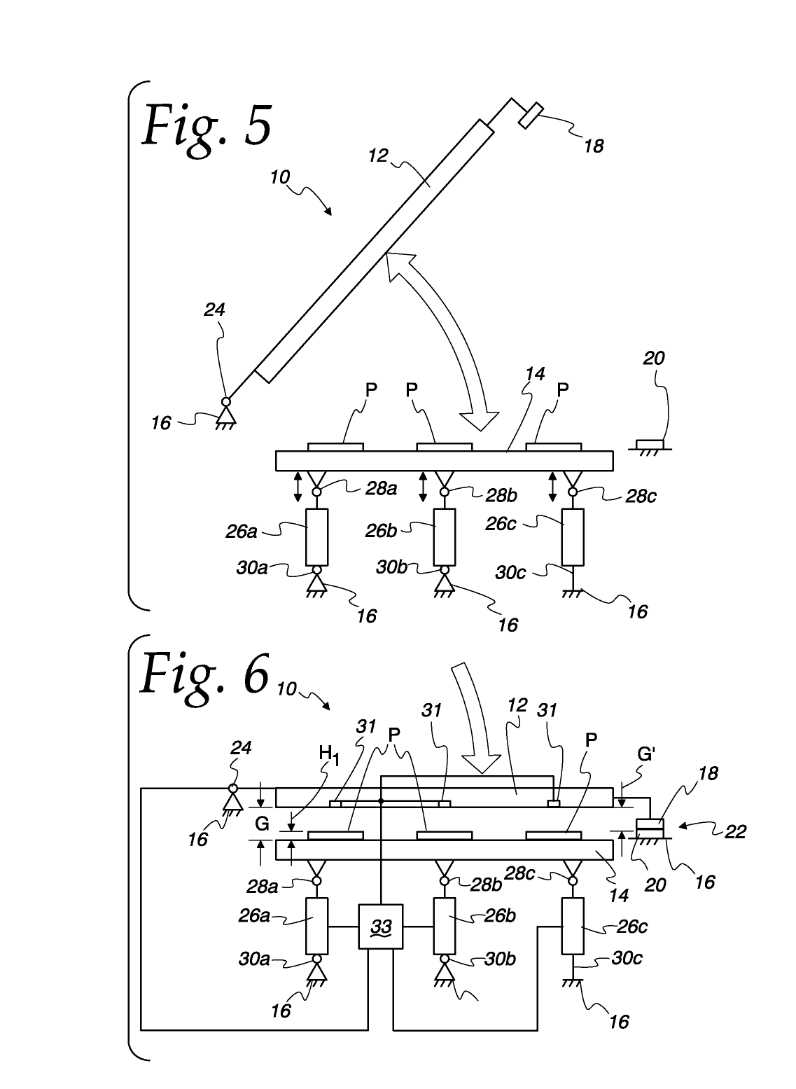

Subsequently, the motive devices are all operated to withdraw their respective portions of lower platen 14 by the same desired distance, preferably slightly larger than the characteristic height of any food item type to be cooked on the grill, to attain a parallel, spaced-apart initial pre-cooking orientation of platens 12 and 14. To permit placement of food items on the grill for cooking, upper platen 12 is raised to the non-cooking position, as shown in FIG. 5, either manually or by an upper-platen motive device (not shown). The motive devices may be operated simultaneously or in any order to withdraw lower platen 14 from the flush or zero-gap position, and likewise, the withdrawal of lower platen 14 and the raising of upper platen 12 to the non-cooking position may be executed simultaneously or in any order. Alternatively, parallelism may be calibrated by any other suitable means, such as by using one or more suitable sensors to measure distances from one of the platen cooking surfaces to three different non-collinear points on the other platen cooking surface, and using motive devices to adjust the distances until they measure the same. Any suitable sequential or simultaneous pattern of adjustments by the motive devices of the three measured distances may be performed to bring them to the same measured distance. For instance, if a prevailing consideration is to arrive at a parallel platen orientation as quickly and efficiently as possible, it may be desirable to simultaneously adjust all three measured distances to a mean distance that is an arithmetic average of the three distances, or to a distance that minimizes the largest difference between the target distance and any of the measured distances.

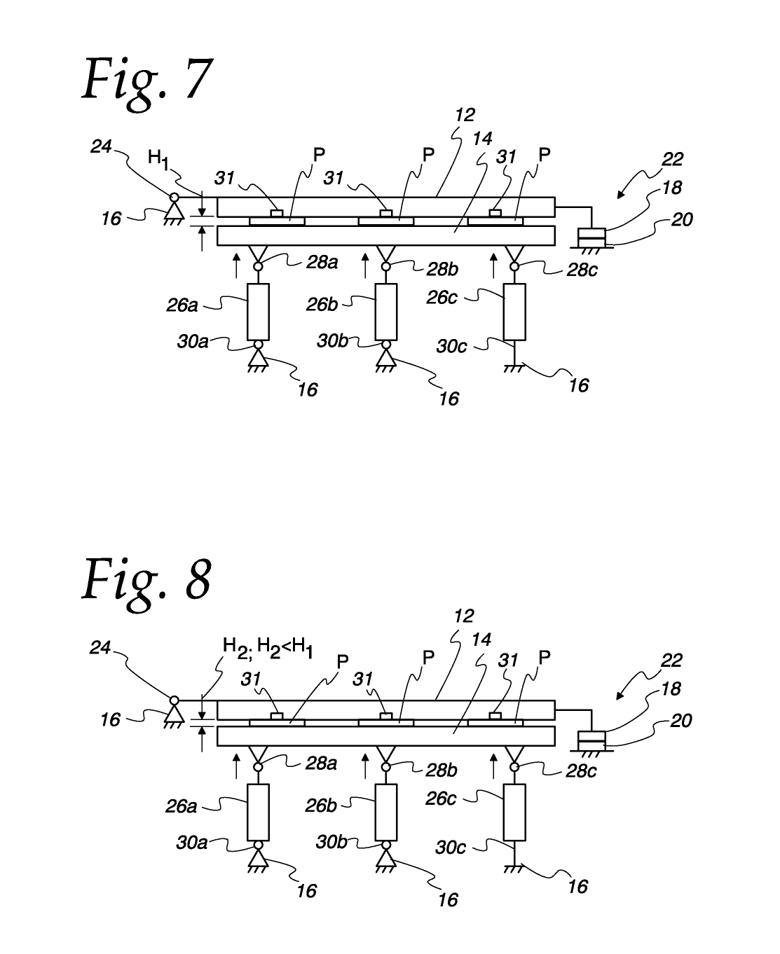

Food items illustrated as hamburger patties P are placed on lower platen 14, and upper platen 12 is returned to the cooking position, reaching a pre-cooking configuration shown in FIG. 6, in which upper platen 12 is separated from lower platen 14 by a vertical gap G, and from the top surface of one or more of patties P by a vertical gap G′. In one embodiment, both gaps G and G′ are detected automatically and used to calculate an initial uncooked height H₁=G−G′ of one or more of patties P. Gap G is typically equal to the distance by which each of motive devices 26a-26c is withdrawn from the zero-gap or flush position to calibrate for parallelism, as noted above, while G′ may be measured by one or more suitable sensors, such as sensors 31 illustrated in FIG. 6 as connected to upper platen 12. Alternatively, lower platen 14 is raised from the initial pre-cooking position until one or more of patties P contacts upper platen 12, as illustrated in FIG. 7, at which point the position of the cooking surface of lower platen 14 relative to that of upper platen 12 is recorded as a measured initial/uncooked height H₁ of patties P. The position could be detected directly by an optical, magnetic, capacitive, mechanical, or other suitable sensor, or inferred from the state of one or more motive devices equipped with a shaft encoder, stepper motors, or some other structure linked to the relative movement of the platens. As shown in FIG. 6, an electronic control processor 33 may be communicatively linked to receive data from sensors 31, motive devices such as linear actuators 26a-26c, and upper platen pivotal joint 24 or any motive device or linkage that drives its rotation, as well as to control the movements of linear actuators 26a-26c and/or any other grill motive devices in accordance with cooking and calibration methods described herein. Optionally, control processor 33 may additionally be linked to restraining structure 22, as when restraining structure 22 includes one or more electromagnetic components, to control the engagement and disengagement of an electromagnetic restraining mechanism.

Measured uncooked height H₁ is then automatically compared by a suitable processor component (not shown) to at least one stored characteristic or nominal uncooked height of a food item type, and if the measured height matches a stored characteristic uncooked height within a predefined margin of variability or error, then the grill automatically executes a stored cooking routine for the identified food item type.

In a preferred embodiment, the cooking routine includes a program of gap distance variation which is defined partly or wholly with respect to the measured initial/uncooked height of one or more of the food items to be cooked (“measured H₁” for ease of reference), or the nominal initial/uncooked height of the food item type (“nominal H₁”). For example, an initial gap, final gap, gap at one or more particular times, average gap, or other parameter may be set equal to measured or nominal H₁, set to differ from measured or nominal H₁ by a particular positive or negative absolute distance, or set to equal the product of measured or nominal H₁ multiplied by a predetermined factor, which may be less than, equal to, or greater than 100%. For example, as shown in FIG. 8, the cooking routine may include raising lower platen 14 while cooking patties P reduce the gap to distance H₂ smaller than H₁.

Reducing the gap to H₂ may or may not entail the upper platen applying a compressive force to patties P (and the lower platen applying a compressive force to patties P greater than their weight), as patties P tend to shrink during cooking irrespective of the application of any external compressive force, due to factors including their ice content melting (if the patties are initially frozen), their liquid water content evaporating, and their solid fat content melting and migrating away from the patties as liquified grease. Accordingly, a certain gap reduction between the platens may be required merely to maintain contact of the upper platen on the patties during cooking. In addition, reducing the gap to an even smaller distance than required to maintain contact may be desirable at some point during a cooking routine, as compressing the patties tends to provide benefits such as accelerating the heating of the patty centers to a safe or otherwise desired temperature, as well as promoting uniform cooking of the patties across their height or thickness dimension, and providing a leaner cooked product by expelling liquified fat from the patty interiors.

On the other hand, additionally or alternatively, it may also be desirable to increase the gap distance to a larger distance than the height of the patties at some point during the cooking routine (such as by returning the lower platen to the position illustrated in FIG. 6), and then to reduce the gap again to bring the upper platen back into contact with the patties and resume two-sided contact grilling. Potential benefits of separating upper platen 12 from the top surface of patties P at some point during cooking include facilitating the release of a certain amount of vapor (thus relieving interior pressure and reducing the risk of blow-holes forming in patties) or moisture content via a clearance space between the tops of the patties and the upper platen cooking surface. Various useful cooking routines and gap spacings and other relevant information, including materials of construction, platen heating arrangements and microprocessor control, for example, is disclosed in U.S. Pat. No. 8,555,777, the entire disclosure of which is incorporated by reference.

Typically, the program of gap distance variation with respect to time may approximate a step function, by holding the gap distance for a predetermined period of time at one or more distances defined as a percentage (which may be less than, equal to, or even greater than 100%) of the measured or nominal height, relatively quickly adjusting the gap distance to a different percentage of the measured or nominal height, maintaining the different gap distance for a subsequent predetermined time period, and so on.

Alternatively, variation in the gap distance over time may be generally continuous, for example approximating a ramp or other constantly varying function. Again, even in the case of gap distance as a continuously varying function, one or more parameters defining or characterizing the function over the cooking period, such as a mean distance, peak or minimum distance, or initial or final distance, may be defined in proportion to the initial measured or nominal uncooked height.

In the preferred embodiment, the program of gap variation between the cooking surfaces of platens 12 and 14 during cooking is controlled by raising and lowering lower platen 14 using motive devices 26a-c. Preferably the upper platen is in a fixed position, so that any compression of food items being cooked will be performed by motors actively applying upward pressure on the lower platen, rather than by the passive weight of the upper platen. This will tend to provide more precise control of the gap spacing during cooking than, for example, suspending the upper platen from cables, belts, or other flexible members, relying solely on the weight of the upper platen to provide any compression of the food items, in which case the present inventors have observed that the stiffness of the food items may counterbalance the weight of the platen to prevent the platen from settling to a fully taut state of the flexible members.

Turning to FIG. 9a, an alternative embodiment of the invention is schematically illustrated as a two-sided grill 32 supported by a base 34. As noted above with respect to base 16, it will be understood that the use of like reference numerals refer to like elements or structure to designate various fixed supporting structures does not mean that they are necessarily integral or contiguous, but only that they are all fixed with respect to one another to define a reference frame and to support the grill components. Grill 32 includes an upper platen 36 movably mounted with respect to an upper platen housing 38, which in turn is pivotally connected to base 34 by a pivotal joint 40. An upper platen housing restraining component 42, in fixed relation to upper platen housing 38, cooperates with a fixed restraining component 44, in fixed relation to base 34, to form a restraining structure 46 restraining movement of upper platen housing 38 away from a cooking position, analogously to the structure and function of restraining structure 22 illustrated in FIGS. 1-8 for restraining movement of upper platen 12 away from a cooking position. By fixing the position of upper platen housing 38, without fixing the position of upper platen 36 itself, grill 32 permits the adjustment of a platen gap spacing by moving either or both of upper and lower platens 36 and 14 using their respective motive devices.

Lower platen 14 of grill 32, its corresponding motive devices 26a-26c, and their respective joints 28a-28c and 30a-30c need not differ from the corresponding structures of grill 10, and are thus designated in FIG. 9a by like numerals as in FIGS. 1-8. Upper platen 36 is illustrated in FIG. 9a as being movably connected to upper platen housing 38 in a manner analogous to the movable connection of lower platen 14 to base 34. In particular, upper platen 36 is driven by the extension and retraction of motive devices 48a, 48b, and 48c, the motive devices being pivotally connected at one end to upper platen 36 by respective pivotal joints 50a, 50b, and 50c, and at an opposite end to upper platen housing 38 by respective pivotal joints 52a, 52b, and 52c.

Another embodiment of a grill in accordance with the invention is also illustrated as grill 32 in FIG. 9a. In this embodiment, the motive device or devices providing vertical movement of lower platen 14 (shown as linear actuators 26a-26c) are primarily or exclusively used for gross, uniform vertical movement of lower platen 14, while finer vertical movements and/or any necessary tilt adjustments for parallelism may be executed by the motive devices that control the movement of upper platen 12 relative to upper platen housing 38, shown as linear actuators 48a-48c. In the particular example shown, linear actuators 26a-26c would be extended and retracted by the same distance to provide gross vertical movement of lower platen 14. In another example of this embodiment, linear actuators 26a-26c may be replaced by a single linear actuator or motive device, such as linear actuator 104 described with respect to FIG. 9c, connected at one end to lower platen 14 by a fixed or solid joint, and at another end to a fixed base or other suitable support structure.

With reference to FIG. 9b, an alternative two-sided grill 82 is illustrated, which is similar to two-sided grill 32 in that grill 82 includes an upper platen 84 movably mounted to a pivotable upper platen housing 86 by a motive device or devices, depicted for purposes of illustration as three linear actuators 100a, 100b, and 100c. However, unlike grill 32, grill 82 includes a lower platen 88 that is fixed with respect to a base 90 to which upper platen housing 86 is pivotally mounted by a pivotal joint 92. A restraining structure 94 comprising one or more (spaced apart) of an upper platen housing restraining component 96 cooperating with one or more (spaced apart) of a lower platen restraining component 98 operates to restrain movement of upper platen housing component 96 away from a cooking position with respect to lower platen 88. Because lower platen 88 is fixed with respect to base 90, restraining structure 94 is kinematically equivalent to an alternative restraining structure 94′, depicted in dashed lines in FIG. 9b to indicate an alternative configuration, in which an upper platen housing restraining component 96′ cooperates with a fixed restraining component 98′, the latter fixed with respect to base 90. However, the structural difference of a restraining structure 94 being located directly over lower platen 88, or over a lateral extension thereof instead of beyond an end of lower platen 88, may provide a significant ergonomic advantage over restraining structure 94′. That is, eliminating the portion of base 90 positioned beyond a front end of lower platen 88, and restraining structure 94′ and associated elements, may allow an operator to stand closer to platens 84 and 88, thus reducing the distance that an operator would be required to reach to place or remove the patties closest to the rear side of the grill (proximate to pivotal joint 92).

Another embodiment of a clamshell grill with an alternative arrangement for vertical movement and tilting adjustment of lower platen 14 is illustrated schematically in FIG. 9c as grill 101. Grill 101 is illustrated as supported by a base 103, which supports upper platen 12 by pivotal joint 24 and retaining structure 22 as illustrated for grill 10 as described above. Tilting adjustment and optionally fine vertical adjustments of lower platen 14 are driven by linear actuators 26′a, 26′b, and 26′c, connected to lower platen 14 by ball/universal or equivalent joints 28′a, 28′b, and 28′c analogously to linear actuators 26a-26c as described for grill 10 above. However, instead of being supported by a fixed base, linear actuators 26′a-26′c are connected at their lower ends to a vertically movable platform 102 by respective ball/universal/equivalent joints 30′a and 30′b and solid joint 30′c. Thus, gross vertical movement of lower platen 14 is provided by a linear actuator 104 connected at an upper end to platform 102 by a solid joint 104 and to base 103 by a solid joint 108.

One skilled in the art will understand that a similar arrangement to that depicted in 9c of independent motive devices for gross and fine movements of lower platen 14 relative to a fixed base may also be provided for gross and fine movements of an upper platen, typically relative to an upper platen housing that is itself mounted for movement relative to a fixed base. Advantageously, controlling gross vertical movement of a platen with a single motive device, as opposed to plural motive devices associated with different portions of the platen, may better ensure uniform vertical movement of all portions of the platen (i.e., avoid producing inadvertent tilting of the platen during gross vertical movement). Further, in the case of the motive devices being telescoping linear actuators, the adjusting actuators (illustrated as linear actuators 26′a-26′c) may be made much smaller if they are not required to produce gross vertical movement, potentially providing net cost and/or space savings.

In accordance with another aspect of the invention, clamshell grills having release sheet attachment arrangements that facilitate liquid grease or other fluids that may emanate from food being cooked migrating away from the platens will now be described. This aspect of the invention synergistically complements the above-described improvements to gap and parallelism measurement and control, facilitates cleaning and also helps to avoid and/or decrease any cumulative fouling of one or both platens or their housings or mounting structures, for example by grease or other food and related materials produced during cooking, can interfere with parallel alignment or other operation of the platens.

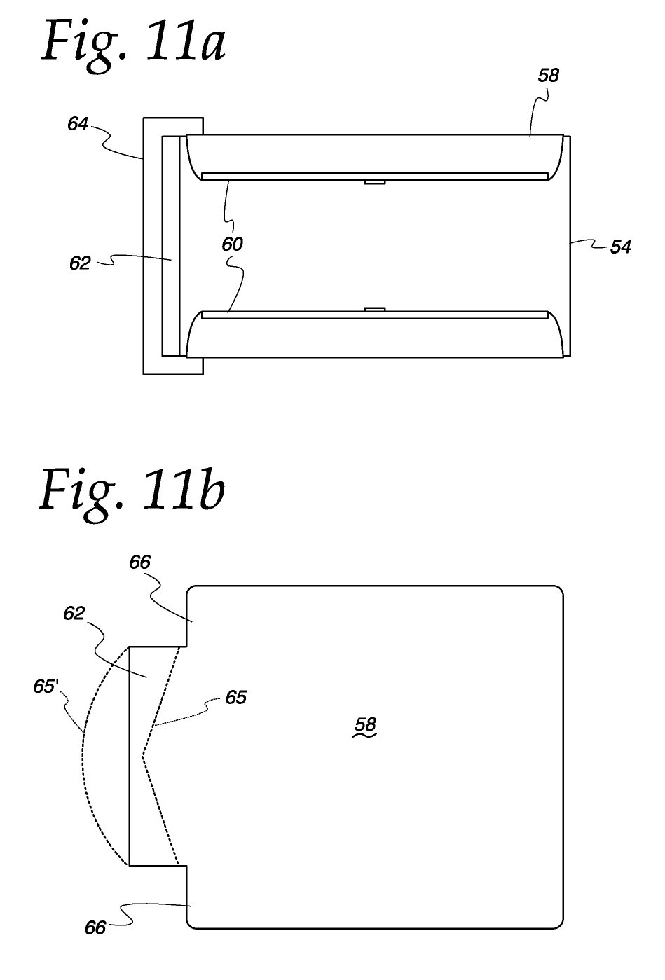

Turning to FIG. 10, an improved release sheet arrangement according to the invention is illustrated schematically for a grill including an upper platen 54 and a lower platen 56. Platen mounting structure is omitted for ease of illustration of the structure and function of an upper platen release sheet 58, but platens 54 and 56 may, for example, be mounted to a base or support structure in accordance with any of the embodiments described and illustrated above, or variations of them within the scope and spirit of the invention. An attached portion of release sheet 58, generally confined to an area within or near the perimeter of a cooking surface of upper platen 54, may be attached to upper platen 54 by any suitable mechanical, adhesive, or other structure, such as the illustrated clips 60 affixed on or proximate to the top side of upper platen 54, as illustrated in FIGS. 10 and 11a. A terminal portion 62 of release sheet 58 is or includes a downwardly extending portion of release sheet 58′, which may hang or hang freely or otherwise be fastened by suitable structure to typically have some amount of slack and which is preferably contiguous with the attached portion of release sheet 58. In the illustrated embodiment, release sheet 58 extends or wraps over a support member 63 near terminal portion 62, support member 63 being disposed outside the perimeter of upper platen 54 to help prevent terminal portion 62 from resting against a side of lower platen 56. If included, support member 63 can be disposed generally as desired and either at, above or below the cooking surface of upper platen 54, to avoid unwanted obstructing of the splatter or runoff of food waste liquid W′ from a food item such as a patty P and permitting coalescence onto or along terminal portion 62 and subsequent dripping into a grease receptacle 64 where waste W is collected. In other embodiments, terminal portion 62 may simply extend downwardly or hang down or hang freely or otherwise be fastened by suitable structure to typically have some amount of slack from a portion of release sheet 58 near the rear perimeter of a cooking surface of upper platen 54. In this position, terminal portion 62 acts a splash/splatter guard, typically to prevent grease from splashing or splattering toward a rear portion of a grill, proximate to pivotal joint of upper platen 54, as well as facilitating the migration and handling of grease and other material, typically liquid, as a result of the food products being cooked from the attached portion of release sheet 58 away from upper platen 54 by allowing grease and other material to flow or traverse across a single continuous surface and to flow or drip from terminal portion 62 into a grease receptacle 64, into or over which terminal portion 62 extends as shown in FIG. 10. Turning to FIG. 11b, various shapes of release sheet 58 are illustrated, including “wings” 66, to facilitate wrapping of release sheet 58 over a top side of upper platen 54 for clipping, and terminal portion 62, on the underside 62′ of which grease may traverse and travel by gravity into receptacle 64 for subsequent disposal or other use. Various shapes for the terminal portion may be generally as desired and may be at least generally rectangular with square corners as shown for terminal portion 62 (or rounded corners 62′), generally triangular 63 or curved 63′, as illustrated in dotted lines.

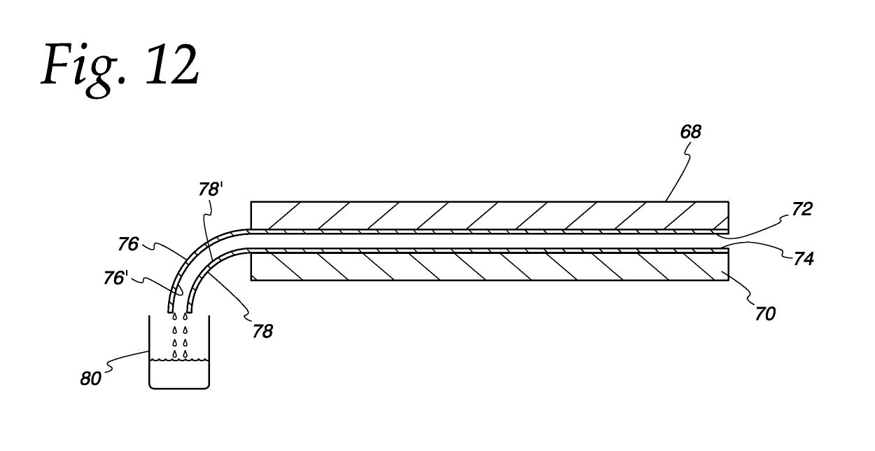

With reference to FIG. 12, another aspect of the invention is illustrated schematically in which both an upper platen 68 and a lower platen 70 have respective release sheets 72 and 74, release sheets 72 and 74 each including a respective contiguous terminal portion 76 and 78 that may each have a shape as desired such as the shapes described with respect to terminal portions 62, 65 and 65′, for example. Any supporting structure that may be employed for either or both terminal portions 76 and 78, such as support member 63 is not shown, to keep terminal portions separated from each other as shown schematically in FIG. 12. Terminal portions 76 and 78 each extend over or into a waste receiving location where a grease receptacle 80 can be located, to facilitate migration of liquid grease or other liquid matter from platens 68 and 70 into grease receptacle 80, in a manner similar to that described with respect to terminal portion 62. As illustrated in FIG. 12, the material from the food cooking traverses and travels by gravity between and along underside 76′ of terminal portion 76 and upper side 78′ of terminal portion 78. Alternatively, only release sheet 74 has a contiguous portion 78 as described above that extends over or into a waste or grease receptacle-receiving location where grease receptacle 80 can be located.

It is to be understood that in alternative embodiments of the present invention, two or more spaced apart and suitably sized as desired side by side upper platens (i.e., any of upper platens 12, 36, 54, 68 and 84) could be utilized with their respective associated components, with an associated lower platen (i.e., any of lower platens 14, 56, 70 and 88) also being suitably sized and configured to cooperate with the cooking area and size of the upper platens.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A grill device for simultaneous two-sided cooking comprising
an upper cooking platen and a lower cooking platen, the upper cooking platen mounted for at least one degree of freedom of movement relative to the lower cooking platen for movement between a cooking position and a non-cooking position; and
the lower cooking platen mounted in generally opposed relation to the upper cooking platen in the cooking position, the lower platen mounted for vertical movement of the lower platen from a non-cooking position substantially below the upper platen in the cooking position to a lower platen cooking position in which the lower platen is closer to the upper platen.

2. The grill of claim 1 wherein the upper cooking platen is mounted to a support structure for movement consisting only of rotation about a generally horizontal axis in fixed relation to said support structure.

3. The grill of claim 1, further comprising means for fixing the position of the upper cooking platen in the cooking position.

4. The grill of claim 1, further comprising automated means for vertically moving the lower platen.

5. The grill of claim 4, the automated means for vertically moving the lower platen being configured to control the vertical position of the lower platen relative to the upper platen when the upper platen is in the cooking position.

6. The grill of claim 5, the automated means for vertically moving the lower platen comprising a prime mover operatively connected to the lower platen by an at least substantially rigid mechanical linkage.

7. The grill of claim 4, the automated means for vertically moving the lower platen configured to control a force applied to the lower platen cooking surface.

8. The grill of claim 4, the automated means for vertically moving the lower platen including independent means for vertically moving at least two different portions of the lower platen.

9. The grill of claim 8, further comprising means for automatically determining whether a cooking surface of the lower platen is at least substantially parallel to a cooking surface of the upper platen.

10. A device for simultaneous two-sided cooking comprising
a support structure;
an upper cooking platen mounted to a support structure for movement relative to the support structure between a cooking position and a non-cooking position;
means for selectively fixing the upper cooking platen in the cooking position relative to the support structure; and
a lower cooking platen mounted to said support structure, in generally opposed relation to the upper cooking platen in the cooking position, for vertical movement relative to said support structure.

11. A method of cooking food item using a two-sided grill having automated control and opposed upper and lower cooking platens comprising:
placing at least one food item having a nominal height on a lower cooking platen of a grill;
moving at least one of the upper cooking platen and the lower cooking platen toward the opposed cooking platen;
sensing when the upper cooking platen first contacts the food item;
automatically determining the distance between the platens when the upper cooking platen first contacts the food item by measuring the distance between the upper cooking platen and the lower cooking platen when the upper cooking platen first contacts the food item; and
automatically executing a cooking routine stored in the memory for the food item type, the cooking routine comprising moving the platens relative to each other to at least a first cooking distance between the platens equal to a first percentage of the measured distance defined by the cooking routine and heating the food item between the platens at the first cooking distance for a period of time determined by the automated control.

12. The method of claim 11, the cooking routine further including moving the platens to a second cooking distance equal to a second percentage, different from the first percentage, of the measured distance defined by the cooking routine and heating the food item between the platens separated by the second cooking distance for a period of time determined by the automated control.

13. The method of claim 11 further comprising identifying the type of the food item based on a comparison of the measured distance to a nominal height of at least one food item stored in a computer accessible memory.

14. The method of claim 11 wherein the first percentage is less than the actual determined distance.

15. A method of cooking a type of a food item using a two-sided grill having upper and lower cooking platens connected to a support structure, comprising
placing at least one food item having a nominal height on the lower cooking platen;
positioning the upper cooking platen in a cooking position relative to the support structure, the upper cooking platen in the cooking position being opposed and approximately parallel to the lower cooking platen;
moving the lower cooking platen toward the upper cooking platen;
sensing when the upper cooking platen first contacts the food item;
automatically determining the actual thickness of the food item by determining the distance between the platens when the upper cooking platen first contacts the food item by measuring with at least one distance measuring sensor the distance between the upper cooking platen and the lower cooking platen when the upper cooking platen first contacts the food item;
identifying the type of the food item based on the distance compared to the nominal height of at least one food item stored in a computer accessible memory;
automatically executing a cooking routine stored in the memory for the food item type to cook the food item after identifying the food item type;
wherein the cooking routine includes adjusting and automatically maintaining for a period of time the distance between the platens to at least one cooking distance equal to a percentage of the automatically determined actual thickness defined by the cooking routine and heating the food item between the platens at the at least one cooking distance.

16. The method of claim 15, wherein the cooking routine includes adjusting the distance between the platens to at least one cooking distance equal to a percentage of the measured distance defined by the cooking routine and heating the food item between the platens at the at least one cooking distance.

17. The method of claim 15, further comprising, after positioning the upper cooking platen in the cooking position, and before the upper cooking platen first contacts the food item, fixing the vertical position of the upper cooking platen.

18. The method of claim 17, said positioning the upper cooking platen in the cooking position comprising moving the vertical position of at least a portion of the upper cooking platen to the cooking position before fixing the vertical position of the upper cooking platen.

19. A grill for simultaneous two-sided cooking comprising
an upper cooking platen;
a lower cooking platen disposed generally opposite the upper cooking platen when the cooking platens are disposed for cooking;
a non-stick cooking sheet removably attached to the upper cooking platen to cover at least a portion of a cooking surface of the upper cooking platen, a terminal portion of the non-stick cooking sheet extending downwardly relative to a portion of the release sheet in contact with the upper cooking platen when in the cooking position; and
a liquid cooking waste receptacle disposed generally below the terminal portion of the non-stick cooking sheet, the terminal portion of the non-stick cooking sheet extending over or into the liquid cooking waste receptacle.

20. A method of simultaneous two-sided cooking comprising
providing an upper cooking platen and a lower cooking platen, the upper platen mounted for at least one degree of freedom of movement relative to the lower platen for movement between an upper platen cooking position and an upper platen non-cooking position, and the lower platen mounted in generally opposed relation to the upper platen in the cooking position, the lower platen mounted for vertical movement of the lower platen from a lower platen non-cooking position substantially below the upper platen in the cooking position to a lower platen cooking position in which the lower platen is closer to the upper platen;
placing a food item to be cooked on a cooking surface of the lower platen in the lower platen non-cooking position, the food item having a vertical dimension that is smaller than the distance between the lower platen cooking surface in the non-cooking position and the cooking surface of the upper platen in the cooking position;
moving the upper platen to the upper platen cooking position;
moving the lower platen to the lower platen cooking position; and
simultaneously cooking a top side of the food item in contact with the upper platen in the upper platen cooking position and a bottom side of the food item in contact with the lower platen in the lower platen cooking position.

21. The method of claim 20, wherein the upper platen reaches the cooking position without contacting the food item, further comprising raising the lower platen after the upper platen reaches the cooking position to cause initial contact of the food item on the upper platen in the cooking position.

22. The method of claim 21, wherein the food item initially contacts the upper platen when the lower platen is at least approximately in the lower platen cooking position.

23. The method of 22, wherein the food item initially contacts the upper platen before the lower platen reaches the lower platen cooking position, and moving the lower platen to the lower platen cooking position comprises compressing the food item between the upper and lower platens.

24. A grill device for simultaneous two-sided cooking comprising
an upper cooking platen and a lower cooking platen disposed in generally opposed relation to each other when each platen is in a respective cooking position;
at least a first one of the platens being driven by a gross vertical motive device for gross vertical movement from a first platen non-cooking position, substantially vertically separated from the second platen in the second platen cooking position, to a first platen cooking position in which the first platen is closer to the second platen; and
at least one of the platens being driven by a fine tilting motive device independent of the gross vertical motive device for fine tilting movement about at least two generally horizontal axes.

25. The grill device of claim 24, the gross vertical motive device producing a range of vertical motion of the first platen greater than a range of vertical motion of any part of the at least one of the platens provided by the fine tilting movement produced by the fine tilting motive device.

26. The grill device of claim 24, the gross vertical motive device comprising a gross movement linear actuator, and the fine tilting motive device comprising a plurality of fine adjustment linear actuators, each of said gross movement and fine adjustment linear actuators having a fully extended length and a fully retracted length, the gross movement linear actuator having the largest difference between its fully extended length and its fully retracted length.

27. The grill device of claim 24, the first platen being driven by the fine tilting motive device, the fine tilting motive device being connected between the first platen and the gross vertical motive device.

28. A method of two-sided cooking with an upper cooking platen and a lower cooking platen disposed generally opposite the upper cooking platen when the cooking platens are in respective upper and lower platen cooking positions comprising
removably attaching a non-stick cooking sheet to at least one of the upper and lower cooking platens to cover at least a portion of a cooking surface of that cooking platen, so that a terminal portion of the non-stick cooking sheet extends downwardly from a location proximate to that cooking platen surface having the release sheet when that cooking platen is in the cooking position to a location generally above or within a liquid cooking waste receiving location disposed generally below the cooking platens; and
cooking a food item on the grill to cause liquid cooking waste to contact the terminal portion of the non-stick cooking sheet and to enter the liquid cooking waste receiving location from the terminal portion of the non-stick cooking sheet.

29. The method of claim 28 further comprising positioning a waste receiving receptacle at the waste receiving location and then collecting waste in the waste receiving receptacle.

30. The method of claim 28, wherein the at least one of the upper and lower cooking platens is the upper platen and further comprising removably positioning a lower non-stick cooking sheet on the lower cooking platen to cover at least a portion of a cooking surface of the lower cooking platen, so that a terminal portion of the lower non-stick cooking sheet extends downwardly from a location proximate to the lower cooking platen surface in the lower platen cooking position to a location generally above or within the liquid cooking waste receptacle, and causing liquid cooking waste to contact the terminal portion of the lower non-stick cooking sheet and to enter the liquid cooking waste receptacle from the terminal portion of the lower non-stick cooking sheet.
